(19) United States
(12) Patent Application Publication
(10) Pub. No.: US 2014/0337353 A1
(43) Pub. Date: Nov. 13, 2014

(54) Bio Data Filter Interpretation Apparatus

(71) Applicants: Michael P. Hickey, Boulder, CO (US); Rebecca Sue MacAskill, Boulder, CO (US)

(72) Inventors: Michael P. Hickey, Boulder, CO (US); Rebecca Sue MacAskill, Boulder, CO (US)

(21) Appl. No.: 13/892,620

(22) Filed: May 13, 2013

(51) Int. Cl. G06F 19/00

(52) U.S. Cl. CPC G06F 19/3443
USPC 707/741

(57) ABSTRACT

A therapeutic optimization platform is described that encompasses a bio data filter interpretation apparatus for the purpose of selecting, validating and optimizing digital health content by way of linking the clinician and patient with meaningful medical data.

### CONTINUITY DATA

The following application is a non-provisional application of provisional application No. 61/624,553, filed on May 11, 2012, and priority is claimed thereto.

### FIELD OF THE PRESENT INVENTION

The present invention is related to the emerging field of digital medicine and mobile medicine, sometimes referred to as mHealth. This field of mobile medicine is explosive. To a great degree this explosive potential is because the field anticipates that intensifying the linkage between patients and various components of the health care system will result in improve efficiency in health care and a long-term expectation that this linkage will also improve the effectiveness of health care.

### BACKGROUND OF THE PRESENT INVENTION

Medial data interpretation is a very sensitive area as it can affect the health of people. The frontier aspects of the World Wide Web have produced much good information and much bad information. This may be suitable for many web applications but not for medical applications where responsibility for information is critical. A patient who is engaged and responsible for their health and therapeutic progress is a patient that remains healthier longer and enhances the effectiveness of therapeutic intervention. When patients are not engaged in the maintenance of their health or detached from aiding in their therapeutic progress, health is diminished and diseases and injuries take longer to manage and sometimes become incurable. An invention that can aid patients in the act of engagement in their own health and therapeutic progress would be useful. The utility of this invention would be to engage patients in an entertaining and meaningful way to pay attention to and engage in actions that would aid clinicians in optimizing various therapies and validate and optimize these engagements.

The present invention is intended to expand the therapeutic space by correlating a Therapeutic Information Object with recommended actions and optimizing the patient action sets through feedback. This invention allows clinicians to build a Therapeutic Information Object during the course of a therapy and to use this data object to search through a collection of patient action programs to select, validate and optimize digital recommendations within a software application.

Patients who are properly engaged in their health not only maintain greater health and reduce time and costs in therapeutic interventions but these patients also develop a sense of empowerment in their health issues. Many studies have demonstrated the effects of optimism and empowerment in the maintenance and enhanced therapeutic progress of populations of patient in various clinical categories. An invention that could make patient engagement valid, optimized, entertaining and informative would aid in patient empowerment and success.

Patients who are properly engaged in their health tend to reduce the cost of health care through the effective and efficient use of health care resources. An invention that could engage patients in an valid, optimized, entertaining and meaningful way would save health care costs by not only helping patients consume health care resources in a more efficient and effect manner but in the case of this invention the underlying data mining potential of the linkage between a Therapeutic Information Object and a Self-Quantified Information Object should add additional dimensions of efficiency by way of selection, validating and optimization of digital programs recommended in software applications.

Doctors would also benefit from additional revenue streams. The current invention is naturally driven by doctor and related clinical professionals providing not only a powerful clinical link to patients but in doing so provide doctors and clinicians a new revenue source that can be leveraged beyond the one-to-one clinical interaction. Doctors and clinicians can manage patient as groups of data sets in addition to their one-on-one therapeutic intervention.

The present invention envisions certified doctors, clinicians and other licensed and certified clinical personnel being able to build from their personal desk tops mobile app modules that link ranges of Therapeutic Information Object with patient action programs and to modify these patient action programs based on data mining feedback with respect to program validation and optimization. In this way a wide range of professional creativity can be developed into the patient action programming. Creative combination of action programs could be developed and group evaluation of these programs provided to both subscribing clinicians and patients.

### SUMMARY OF THE PRESENT INVENTION

The present invention primarily relates to a multi-dimensional filter interpretation module that integrates complex electrophysiological data and treatment outcome data with adjusted application content. The purpose of the invention is to customize various clinical apps to the patient input data thus creating efficiency and effectiveness in matching treatment apps to complex patient data.

The present invention is an apparatus consisting of an input module of data from An Apparatus for Bio-Data Collection and Analysis or various other Electrophysiological Data and/or EMR sources. This data is transmitted to the App module. Patient electrophysiological data is transmitted from the input module to the Filter Module. The filter module evaluates the patient data with respect to a data bank of app content and matches the patient data to specific app content within the app data store. The filter then makes one or more recommendations on selected app content that fits the patent pre, intra and inter treatment profile. The filter module is also capable of setting up the App graphic an analytical calculations based on the patients exact data.

The App module contains various internal modules that are programed into an HTML-5 base. The system provides clinicians and patients various educational modules including but not limited to video, graphics, audio and other instructional modules in order to educate clinician or patients with respect to interpretation of the data. Various content specific variations are constructed as part of the app development that is gauged to correspond to levels of patient data. The apparatus filters are intended to select these sub apps based on patient data characteristics.

The system begins with data collection from the eMet monitor in the clinician's office. This data is transmitted by way of the eMet web portal to a centralized data processing center. At this center the patient data is translated into graphic displays, advanced signal processing and is linked to very large databases of outcome data for further analysis.

This processed patient data is transmitted to the eMet filter which links the processed patient data to a general app content module and selected app modules based on patient data characteristics. Within each customized app is a rating scale for the usefulness of the module to the patient data. These internal ratings are transmitted to the feedback module which compiles the data and the rating and crowd sourced data is used within the filter to further refine the filter.

The present invention relates to a therapeutic optimization apparatus that combines a physiological Therapeutic Information Object with a Self-Quantified Information Object in order to optimize the therapeutic process. The invention is intended to optimize various therapeutic processes by expanding the therapeutic space to guide patient therapeutic activities though digital recommendations and allows for the patient's self-quantification of the guided digital recommendation. Furthermore, the invention envisions merging the patient's self-quantified information with monitored data in order to optimize the therapeutic process. This optimization is achieved by an analysis of the digital recommendations that optimize the therapeutic process as measurement by the Therapeutic Information Object.

The invention envisions the construction of a Therapeutic Information Object composed of monitor data collected during a therapeutic process, a Therapeutic Ranking Index, a Clinical Index and feedback from a Self-Quantified Information Object.

Monitored data is raw or derived data collected by a medical monitor. A Therapeutic Ranking Index is derived from the monitored data. Patterns are located within the monitored data and these patterns are ranked with respect to changes correlated to the therapeutic process. Clinical application data patterns are calculated by correlating the ranked change data across therapeutic time, across therapeutic activities and comparison with population statistics. These measurements are used to build the Therapeutic Information Object and then used to select the most effective set of digital recommendations, validate the effect of the digital recommendation on the Therapeutic Information Object and provide through optimization calculus and other analytic techniques and optimization graph related to the best digital recommendations that affect the Therapeutic Information Object. Subsequent to the patient's utilization of the application digital recommendations the invention envisions the construction of a Self-Quantified Information Object that can become a component of the Therapeutic Information Object.

The present invention envisions a digital recommendation module composed of video, graphics, texts and other digital capabilities to construct a set of digital recommendations for patients to follow which are intended to aid the therapeutic process. The invention provides for a self-quantification platform providing various self-quantification tools for patients to quantify themselves with respect to the digital recommendations. The invention allows for a validation and optimization platform that provides displays and reports on the effectiveness of the digital recommendations on changes in the Therapeutic Information Object.

The invention present envisions the construction of a Self-Quantified Information Object. This information object is composed of a set of digital recommendations and the patient's self-quantification of the effect of the recommendation on their subjective evaluations and objective self-measurements.

### BRIEF DESCRIPTION OF THE DRAWINGS

FIG. 1 shows a flow chart detailing the component processes of the present invention.

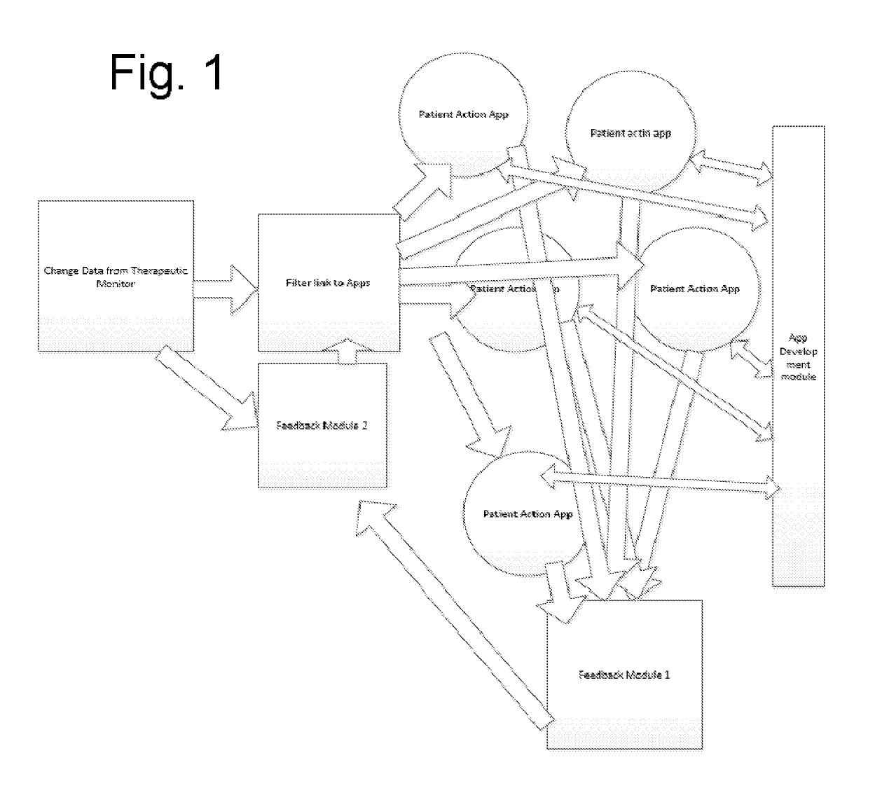

FIG. 2 depicts a flow chart pertaining to the process of the present invention from first treatment to second treatment.

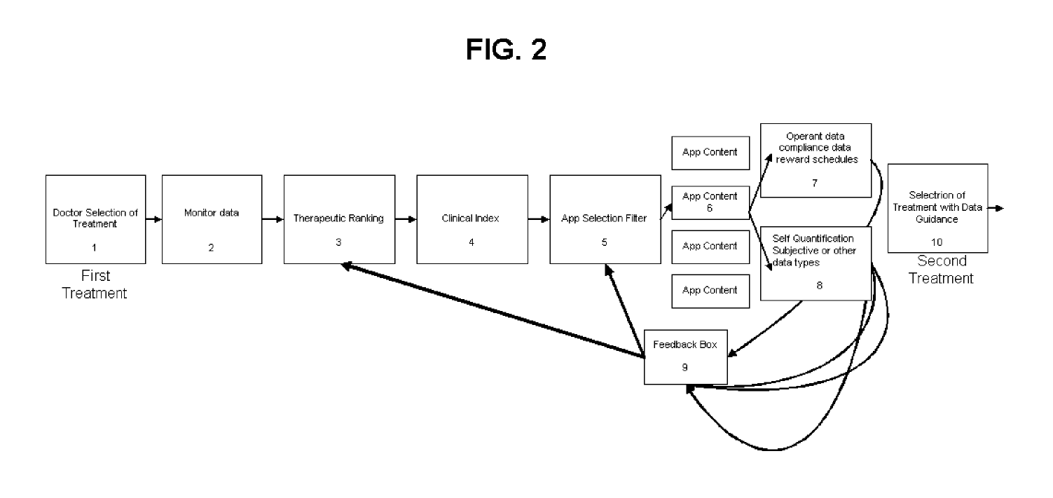

FIG. 3 outlines the arrangement of Feedback Modules for Development of Patient Action Optimization.

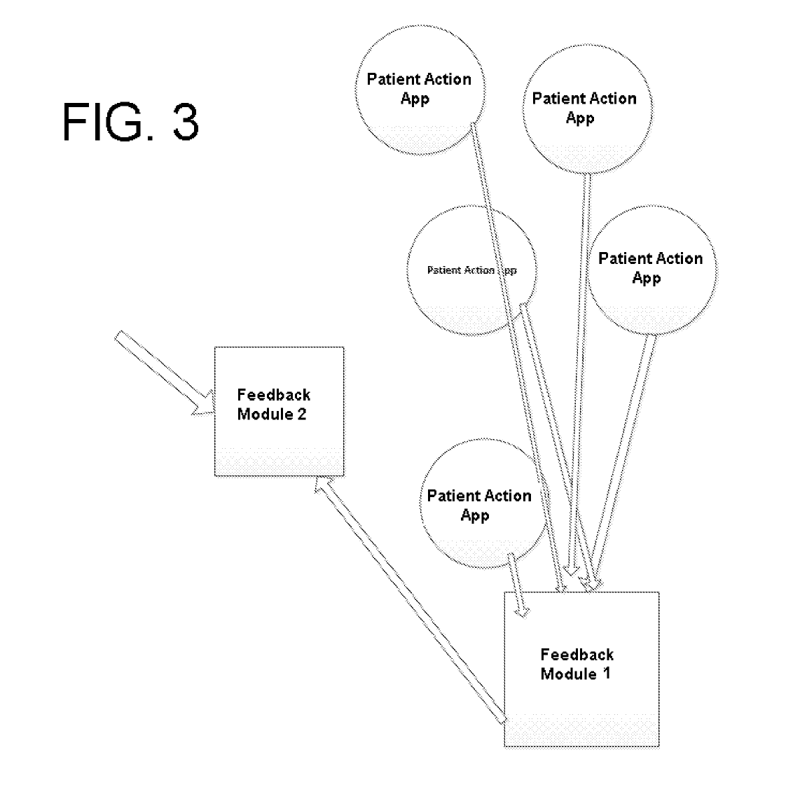

### DETAILED DESCRIPTION OF THE PREFERRED EMBODIMENT

There are two primary embodiments of the present invention. The first embodiment is based on Intra-Therapeutic Monitoring and the second embodiment is Inter-Therapeutic Monitoring.

Intra-Therapeutic Monitoring includes:

Chiropractic Monitoring

Physical Therapy Monitoring

Acupuncture Monitoring

Massage Therapy Monitoring

Yoga Monitoring

Fitness Monitoring

Inter-Therapeutic Monitoring includes:

Hormone Replacement monitoring

Anesthesia Recovery monitoring

Post-Surgical Healing monitoring

Diabetes monitoring

Metabolic Syndrome monitoring

Health Information Banks

### Intra-Therapeutic Monitoring

### Chiropractic Monitoring

For example, a patient walks into a Chiropractic office because of neck pain. The Chiropractic doctor administers an intake evaluation and decides on a course of treatment which includes adjustments, massage therapy, and micro electric stimulation (1). Prior to the patient's adjustment the doctor connects the patient to the eMET device, and monitors and collects both EEG and HRV data. This data is displayed in real time for observation by the doctor and patient. The doctor uses this information display to assure proper monitoring and data collection. (2). The doctor also uses this data to engage the patient's interest in the functioning of their nervous system.

At the end of the session the doctor uploads the data to the eMET server and receives a report back entitled Therapeutic Ranking Index (3). This report identifies the patterns in the EEG, HRV and the combination of EEG and HRV that have changed during the therapeutic adjustment. The doctor can trend the patient's data (this is of course the first treatment) and can compare the patient's data to populations of patients with similar characteristics and conditions. This creates a Clinical Index (4). The Clinical Index allows the doctor and patient to understand and compare the effect of the treatment on the patient's nervous system change function.

The doctor inputs the Therapeutic Ranking Indexes and the Clinical Index into the eMET app selector filter (5). This selector filter compares the patient's Therapeutic Ranking and Clinical Indexes to various content modules that are predicted to optimize the Therapeutic Ranking Index over the course of the treatment plan. The app content is selected and delivered (6) to the patient's mobile devices. The patient views the app content over their mobile device and records the compliance with the recommended content action. The patient records compliance with the recommended actions and receives various reinforcements for compliant action. The app content contains various types of reinforcement schedules (7).

The patient also periodically provides subjective rankings of pain or other quantifications of their subjective reactions (8). Data from the app including stimulus data, compliance data, reward schedule data and subjective ratings are collected by the app and stored in a feedback module. The feedback module organizes the app information and inputs the data to the Therapeutic Ranking Index data mining module (9).

On a subsequent visit the doctor performs similar physical adjustments while monitoring the EEG and HRV data. The doctor and patient and receive a new set of Therapeutic Ranking Indexes and various differences in the ranking indexes between sessions is also reported. This data including all app data is used to as an input to the filter to select a new set in app content that is predicted to aid a future Therapeutic Ranking Index.

A similar process occurs in the patient's micro electric therapy and massage therapy. This data would be aggregated in order to predict the best mobile app content for the patient to engage in for the purpose of optimizing the therapeutic process.

### Physical Therapy Monitoring

A patient walks into a physical therapy office after orthopedic surgery on a knee and needs physical therapy rehabilitation. The physical therapist performs an initial diagnostic evaluation and plans a course of micro stimulation and exercise therapy. (1) During the micro electric therapy the patient is connected to the eMET system and current is apply to the knee requiring therapeutic intervention. The physical therapist observes the raw data collected to insure a good connection. In addition the therapist points out the features in the nervous system data to the patient and also explains the role of the nervous system in the physical healing process noting (when needed) various research studies. This is intended to educate the patient on the role of his nervous system in his healing process and to set the stage for mobile app relevance after the in-office therapeutic process. (2) The clinician collects data during the therapeutic session and at the end of the session the clinician calls up the Therapeutic Ranking Index which shows both the therapist and patient which patterns in the nervous system data that have change the most during the therapeutic process. (3) The benefits of this information are two-fold. First, it tells the therapist the magnitude of change occurring during the therapy and secondly it provides objective evidence to the patient that beneficial nervous system changes are occurring or as yet are not being initiated. The therapist can then call up the Clinical Index Report that trends the data across the session and compares the data to patients like themselves (4). The benefit of this is to again engage the patient in objective information on their nervous system function in the healing process.

The therapist then inputs the patient nervous system data into the eMET app selection filter (5) and the data mining suggests a set of content (6) that may best aid the therapeutic process by predicting more significant change in nervous system data based on predictive indexes. The therapist chooses the mobile app content and it is now available for the patient to revive at home.

The patient downloads this app at home and follows the recommended activity in the app between therapeutic sessions. In addition the patient makes various records in the app with respect to self-quantification data, compliance and behavioral change data. (7 and 8) The app records reinforcement schedule and engagement data. All of this data is store in the system feedback module (9). The feedback module sends this data to the filter selection model to aid in selecting content and to the Therapeutic Ranking module to aid in the data mining predictive indexes of linking content to future indexing change.

In future sessions the therapist begins with a patient review of progress however this is performed with accompanied data (10 need to change 1 to 10).

### Acupuncture Monitoring

The patient walks in to an acupuncture therapist reporting pain in the knee due to a running injury (1). The acupuncturist inserts acupuncture needles in the knee around the reported pain area. In addition the acupuncturist connects the patient to eMET system (2). The acupuncturist use the raw data stream to assure there is a good connection to the system and also explain the data stream to the patient. The benefit of this is to educate the patient as to the functions of the patient nervous system in the acupuncture process. After the acupuncture session the acupuncturist call up a Therapeutic Ranking index report. (2) This report lists the Nervous System Patterns that represent the largest change during the therapeutic session (and between session in future measurements) (3). The acupuncturist also uses the therapeutic ranking indexing data as an input to the Clinical index. The clinical index is used to trend data through time and to compare the patient changes with other population groups both clinical, age etc. (4).

The acupuncturist can input this data aggregate into the app selection filter (5). The app selection filters selects the optimal content module that will predict the most change in future Therapeutic Ranking Indexes. The app allows the patient to record various self-quantification measurements and the app collects various operant behavioral measurements intended to aid in sustain behavior needed to optimize the therapeutic process.

This data is aggregated and sent to the feedback module. The data is organized in the feedback module and sent to the app selection filter and the therapeutic ranking data mining module to aide in future predictive indexing and filter selection (9).

Future session begin with a new assessment with significant data guidance (10).

### Massage Therapy Monitoring

The patient walks into the massage therapist and discusses the physical complaint. (1). The Massage Therapist connects the patient to the eMET System and records nervous system data (2). The benefit of the data is to inform the therapist of good data acquisition and to begin to educate the patient on the relationship of massage to changes their nervous system. After the massage therapy session the therapists accesses the Therapeutic Ranking Index which lists the nervous system patterns that have changed the most. In addition the therapist accesses the Clinical Indexing report which display trends of data and various population comparisons. This aggregated data is inputted into the app selection filter (5). The app selection filter selects the mobile app content module that bests predicts future changes in massage related Therapeutic Ranking Indexes. (6). The mobile app also collects data with respect to behavioral compliance to the app recommendations and various operant reinforcement data (7). In addition the app records various types of self-quantification data (8). This aggregate data is sent to the feedback module where the data is organized (9) and subsequently the data is sent to the app selection filter module and Therapeutic Ranking Index data mining module for the purpose of constructing future indexes. In subsequent massage therapy sessions the therapist's initial assessment is used in the context of data guidance (10).

### Yoga Monitoring

The patient visits an eMET certified Yoga Instructor. This Yoga Instructor is certified by eMET in proper data collection and data interpretation in reference to Yoga instruction. The Yoga instructor discusses Yoga objectives with the patient (1). The Yoga instructor connects one or more Yoga patients to the eMET system and collects raw monitored data (2). The raw monitored data allows the Yoga instructor to insure proper data collection and allows the Yoga instructor to educate the patients on the relationship of Yoga to their nervous system functionality (2). Subsequent to the Yoga session, the Yoga instructor accesses the Therapeutic Ranking Index (3). This Ranking Index shows the patient and Yoga instructor the nervous system patterns that have changed the most during the therapeutic session. The Yoga Instructor can also access the Clinical Indexing system in order to calculate patient trends and comparisons of patients to various populations. (4). This aggregate information can be inputted by the Yoga Instructor into the app selection filter (5) and app content selected based on app content predictive power in aiding changes with Yoga exercises in the Therapeutic Ranking Index (6). Between Yoga sessions the app will collect data on behavioral compliance and reinforcement schedules (7). The app will also collect various types of self-quantification data. (8). All data is aggregated into the feedback module and organized (9). This data is sent to the app selection filter module and Therapeutic Ranking Index for future predictive index development. Future Yoga exercise decision can be made in the context of data guidance. (10).

### Fitness Monitoring

The patient visits an eMET certified Fitness Instructor. This Fitness Instructor is certified by eMET in proper data collection and data interpretation in reference to fitness instruction. The fitness instructor discusses fitness objectives with the patient (1). The fitness instructor connects one or more fitness patients to the eMET system and collects raw monitored data (2). The raw monitored data allows the fitness instructor to insure proper data collection and allows the fitness instructor to educate the patients on the relationship of fitness to their nervous system functionality (2). Subsequent to the fitness session, the fitness instructor accesses the Therapeutic Ranking Index (3). This Ranking Index shows the patient and fitness instructor the nervous system patterns that have changed the most during the therapeutic session. The Yoga Instructor can also access the Clinical Indexing system in order to calculate patient trends and comparisons of patients to various populations. (4). This aggregate information can be inputted by the fitness Instructor into the app selection filter (5) and app content selected based on app content predictive power in aiding changes with Yoga exercises in the Therapeutic Ranking Index (6). Between fitness sessions the app will collect data on behavioral compliance and reinforcement schedules (7). The app will also collect various types of self-quantification data. (8). All data is aggregated into the feedback module and organized (9). This data is sent to the app selection filter module and Therapeutic Ranking Index for future predictive index development. Future fitness exercise decision can be made in the context of data guidance. (10).

### Inter-Therapeutic Monitoring

### Hormone Replacement Monitoring

A patient enters an OB/GYN office. The doctor performs a diagnostic assessment (1) and decides on a course of treatment. The treatment is intended to manage the person's hormone levels. The doctor draws blood for the measurement of hormone related blood constituents and also collects nervous system data by way of the nervous system monitor. (2). The doctor uses the data monitored data to insure a good connection to the monitor and the doctor educates the patient by way of the monitored displayed data with respect to the persons nervous system and the relationship between hormone levels and nervous system data output. During the course of treatment the patient returns to the doctor's office and receives additional nervous system monitoring and blood data collection. The blood data and nervous system data are synthesized into a Therapeutic Ranking Index (3). The Therapeutic Ranking Index is used as an input to the Clinical Index module which informs doctor and patient with respect to trending of data and comparison of patient to various populations (4). The benefits of this data are to establish objective trends, allows the doctor to adjust treatment and inform the patient about their data in comparison to various populations. This data is used as an input to the app selection filter (5).

The app selection filter selects an app content module based on a prediction of the app content's capability to affect a future therapeutic ranking index. (6). The app module collects data on behavioral change including compliance data and rewards schedules (7), as well as various types of self-quantification data (8). This data is organized in the feedback module (9) and sent to the app selection filter and the therapeutic ranking data mining module for the purposes of predictive indexing. Future doctor patient visits begin with the doctor's assessment of the patient in the context of these various indexes (10).

### Anesthesia Recovery Monitoring

A patient receives anesthetic gas as a requirement for surgery. Prior to the surgery the patient is monitored by the eMET monitoring system and Pulse Oximetry readings (2). The eMET raw combined data display provides the anesthesiologist with correct data feedback and allows the Anesthesiologist (or nurse) to educate the patient with respect to the effects of anesthetic agents on the patient's nervous system. The patient can also be monitored during surgical process with both eMET Nervous System Data and Pulse Oximetry data. The Anesthesiologist then collects data post-surgical combined data. (2). This data is uploaded to the Therapeutic Ranking data mining module and a Therapeutic Ranking Index is generated (3).

The clinician can also calculate various clinical indexes that trend the patient across the anesthetic experience and compares the patients to various clinical populations (4). This aggregated data is inputted into the app selection filter (5) and mobile app content is selected (6) which best predicts return to normal measurements of the Therapeutic Ranking Index. The app content module allows for the collection of content compliance and reinforcement schedules (7). It also allows for various types of self-quantification (8). This data aggregation is sent to the feedback module where the data is organized (9). The feedback module sends the data to the app selection filter module and the Therapeutic Ranking Index module for the purpose of future predictive index construction. Future visits to the Anesthesiologist or Primary Care doctor could include additional Oximetry and eMET Nervous System measurements for ongoing app optimization (10).

### Post-Surgical Recovery Monitoring

Doctor recommends a surgical procedure or there is an emergency surgery required. (1) Prior to surgery the patient and in surgical recovery receives nervous system measurements on the eMET platform (2). This data is used to educate the patient with respect to the role of the human nervous plays in post-surgical healing. This data is also used as an input to the data mining module and a Therapeutic Ranking Index is created (3). The Therapeutic Ranking Index and various other surgical data including but not limited to surgical data is used to create a Clinical Index (4). This clinical index reports various trends and compares the patient to various populations. The Therapeutic Index and Clinical Index data are inputted in to the app selection filter (5). The filter selects app content for the purpose of optimizing post-surgical healing (6). The app content also contains operant data which measures behavioral compliance and reinforcement schedules (7). The app content also contains various self-quantification measurements (8). This data is inputted to the feedback module and organized (9). The data is then transmitted to the app selection filter and Therapeutic Ranking Index module for the purpose of building future predictive indexes with respect to the app content's capability to change the Therapeutic Ranking Index. Future visits to the Surgeon or Primary Care doctor could include additional Oximetry and eMET Nervous System measurements for ongoing app optimization. (10)

### Diabetes Monitoring

Once the doctor diagnoses the patient with Diabetes and selects a course of treatment (1); the doctor also begins a series of eMET monitoring studies (2). During the course of Diabetic therapy eMET monitoring data is generated and is aggregated with blood constituent data and is inputted into the Therapeutic Ranking Index (3) and a Therapeutic Ranking Index of nervous system and blood constituent's data is developed. This data is inputted into the Clinical Index Module where trending and various population comparison reports are generated (4). This data is aggregated and inputted into the App Selection filter (5). The filter selects content which is predicted to optimize changes in the Therapeutic Ranking Index (6). The app content also collects operant data related to compliance data and reinforcement schedules (7). The app content also collects data on various self-quantification measurements (8). This aggregated data is sent to the feedback module (9) and is organized. The feedback module inputs data to the App Selection filter and the Therapeutic Ranking Index module for the purpose of aiding in the construction of future predictive indexes. Future visits to the diagnosing physician would include utilization of eMET platform data as guidance for future therapy (10).

### Metabolic Syndrome Monitoring

Once the doctor diagnoses the patient with Metabolic Syndrome and selects a course of treatment (1), the doctor also begins a series of eMET monitoring studies (2). During the course of Metabolic Syndrome therapy eMET monitoring data is generated and is aggregated with blood constituent data, and various cardiac measurements and is inputted into the Therapeutic Ranking Index (3) and a Therapeutic Ranking Index of nervous system, blood constituent data and various cardiac measurements is developed. This data is inputted into the Clinical Index Module where trending and various population comparison reports are generated (4). This data is aggregated and inputted into the App Selection filter (5). The filter selects content which is predicted to optimize changes in the Therapeutic Ranking Index (6). The app content also collects operant data related to compliance data and reinforcement schedules (7). The app content also collects data on various self-quantification measurements (8). This aggregated data is sent to the feedback module (9) and is organized. The feedback module inputs data to the App Selection filter and the Therapeutic Ranking Index module for the purpose of aiding in the construction of future predictive indexes. Future visits to the diagnosing physician would include utilization of eMET platform data as guidance for future therapy (10).

### Health Information Banks Monitoring

During every visit to the doctor (1) the primary care doctor routinely performs an eMET monitoring data collection (2). Over time this data is aggregated and a Therapeutic Ranking Index is developed on the patient lifestyle (3). The Therapeutic Ranking Index data is aggregated with the patient's own Health Information Bank data and various clinical indexes is generated that reports trending and compares the patient's aggregated data to various populations (4). For example, a patient's composite data could be compared to various disease and non-disease populations. This aggregated data is entered into the app selection filter (5) and app content is selected which is predicted to aid the patient in remaining in the non-disease category (6). The app content also collects operant data related to compliance data and reinforcement schedules (7). The app content also collects data on various self-quantification measurements (8). This aggregated data is sent to the feedback module (9) and is organized. The feedback module inputs data to the App Selection filter and the Therapeutic Ranking Index module for the purpose of aiding in the construction of future predictive indexes. Future visits to the physician would include utilization of eMET platform data as guidance for future therapy (10).

I claim:

1. A device and system for monitoring nervous system therapeutic processes and collecting data from a patient during a nervous system therapeutic process comprising:
a data-mining module acquiring data from a therapeutic process monitor;
a computer executing a set of algorithms describing relationships and patterns of the data;
wherein the set of algorithms ranks the patterns with respect to therapeutic change to create a therapeutic ranking index;
the computer analyzing the nervous system therapeutic ranking index with respect to time, types of treatment protocols, and population characteristics to create a clinical index.
the computer combining raw monitored data, the nervous system therapeutic ranking index, and the clinical index, resulting in a therapeutic information object
an input characterization module that acquires information regarding the nervous system therapeutic information object from the data-mining module;
an app development module permitting clinicians to build post therapeutic process digital patient action plans based on the nervous system therapeutic information object ranges;
a characterization filter comparing the nervous system therapeutic information object characterizations from the input module to a list of digital patient action plans from the app development module;
a self-quantification module enabling the patient to develop and record self-quantification data relative to digital patient action plan guidance;
a feedback module 1 recording patient Nervous System self-quantification Nervous System data creating a Nervous System Self Quantification Information Object and integrates the ratings with current and Nervous System Therapeutic Information Object;
a feedback module 2 selecting the optimal digital content correlated with changes in the Nervous System Therapeutic Information Object;
a feedback module 3 validating the digital content with respect to changes in the Nervous System Therapeutic Information Object;
a feedback module 4 that optimizes the digital content with respect to changes in the Nervous System Therapeutic Information Object; and
a Nervous System Operant Information Module that calculates, predicts and optimizes the magnitude of behavior change comprising a stimulus measurement, response measurement, reinforcement schedule measurement linked with a measurement of behavior change.
